(19) United States
(12) Patent Application Publication
(10) Pub. No.: US 2008/0156553 A1
(43) Pub. Date: Jul. 3, 2008

(54) Advanced hybrid golf car

(76) Inventor: Reinier Hoogenraad, Chino, CA (US)

Correspondence Address: WILLIAM G. LANE;WILLIAM G. LANE, INC., PC, 16485 LAGUNA CANYON RD, SUITE 250, IRVINE, CA, 92618, US

(21) Appl. No.: 11/982,303

(22) Filed: Oct. 31, 2007

Related U.S. Application Data
(63) Continuation-in-part of application No. 11/642,244, filed on Dec. 20, 2006.

(51) Int. Cl. B60K 6/20; H02J 7/00; G06F 19/00

(52) U.S. Cl. 180/65.2; 701/99; 320/137; 903/906; 903/942

(57) ABSTRACT

A hybrid golf car type vehicle powered by a gasoline engine or an electric motor in the forward direction and by the electric motor in the reverse direction with the gasoline engine charging the batteries when the batteries fall below a threshold charge either with a motor generator or an alternator.

This is a continuation-in-part of U.S. patent application Ser. No. 11/642,244, filed on Dec. 20, 2006, now pending; and PCT/US2006/048511, filed Dec. 20, 2006; and claims the benefit of U.S. Provisional Application No. 60/753,662, filed on Dec. 23, 2005.

This application incorporates by reference the entire specification and disclosure of U.S. patent application Ser. No. 11/642,244, and U.S. Provisional Application No. 60/753,662.

### FIELD OF THE INVENTION

The present invention is directed to a hydrogen/hydrocarbon fuel hybrid golf car type vehicle, sometimes referred to as a golf cart. This type of vehicle used by golfers, gardeners and maintenance people in a park or development, and by people on residential streets where high speeds, such as 60 miles-per-hour are rare and not required.

### BACKGROUND OF THE INVENTION

Golf car type vehicles have been around for at least 60 years. Originally, both gasoline engine powered and electric motor powered golf cars were available. Because of improvements in motor technology and battery technology, electric powered golf car type vehicles have prevailed. However, gasoline powered golf car type vehicles are available and are used in situations where higher speeds are required and/or higher loads are being carried or towed.

Hybrid automobiles have become very popular over the last decade. These automobiles have both a gasoline engine and an electric motor connected to a transmission and have a relatively large battery pack to power the electric motor. The hybrid vehicle has been successful primarily because of technology advancements in microprocessing, transmission and batteries. Batteries based on a given weight have a far greater charge or ability to take a charge than the batteries of 20 or 30 years ago. It has been the computer controlled transmission and engine that has really made the hybrid vehicle possible. At high speeds and/or high loads or at low battery charges, the transmission is driven primarily by the gasoline engine. At lower speeds when there is a sufficient charge, the electric motor handles most of the power requirements for the vehicle. When the vehicle comes to a stop, such as at a stop sign or a signal, if the gasoline engine is operating, after being stopped for a predetermined period of time, such as two or three seconds, the engine is turned off. When the driver commences to move the car, the transmission is powered by the electric motor first. The engine is started when the car moves out and kicks in to take up the power requirements during acceleration. Use of sophisticated computer controlled transmissions has not made its way to the golf car type vehicles for a variety of reasons, including cost, weight and power losses that are experienced through any transmission. For a vehicle having an engine from 100 to 200 horsepower, the power losses through the transmission are de minimis. However, for a golf car type vehicle where the electric motor is normally in the 5 to 10 horsepower and a gasoline engine is from 7.5 to 15 horsepower range, the power losses in a computer controlled automatic transmission are prohibitive.

An electric motor powered golf car type vehicle normally is easy to place in reverse by activating a switch that reverses the polarity of the current being fed to the motor and reverses direction of the motor. When the golf car is powered by a gasoline engine, reversing directions of a golf car type vehicle becomes relatively complicated and requires, at a minimum, a clutching system to switch power from one pulley to another pulley where one pulley powers an endless belt to move the vehicle in a forward direction and the other pulley powers the vehicle to go in a reverse direction. The clutching system activates one pulley or the other pulley depending upon what direction the vehicle wants to go. Because of the power limitations of the gasoline engine for a small golf car type vehicle, the weight of a transmission and clutch, the complexity of a transmission and clutch, and the cost of a transmission and clutch, transmissions with a clutch having forward direction[s] and at least one reverse direction, have not been widely utilized in small golf car type vehicles. The reverse direction problem has been one of the most difficult problems facing the use of a gasoline powered engine in the golf car type vehicles.

The gasoline engine produces carbon monoxide, carbon dioxide, water, partially combusted fuel and uncombusted fuel. The automobile passes it exhaust through a catalytic converter to oxidize the carbon monoxide to carbon dioxide and fully combust partially combusted and uncombusted fuel. The use of a catalytic converter is a sophisticated device having sensors that are monitored by a microprocessor that adjusts the engine air intake and fuel to air ratio to control the combustion and exhaust temperature and the exhaust mix in order to have the catalytic converter work at its optimum to reduce pollutants to the air.

The catalytic converter technology is too expensive and complex to be used on a golf cart type vehicle.

Even if a gasoline engine could achieve complete combustion and convert the gasoline to carbon dioxide and water, it still contributes to the greenhouse effect because of the release of carbon dioxide.

Gasoline is a mix of hydrocarbons from a distillate fraction. For purposes of computing the energy, and carbon and hydrogen content of gasoline, gasoline is treated as hexane, C₆H₁₄ even though the gasoline mix has C₄ to C₁₂ hydrocarbons. Thus each gallon of gasoline, if fully combusted to carbon dioxide and water, produces almost 20 pounds of carbon dioxide. Each time someone burns a full tank of gas (20 gallons), they release close to 400 pounds of carbon dioxide into the atmosphere.

Hydrogen is a marvelous fuel. It readily burns in air producing water. The combustion is normally complete if there is at least a stoichiometric amount of oxygen present. No carbon dioxide is produced in the combustion of hydrogen.

It will be ideal from an environmental point of view to run a hybrid golf cart engine on 100 percent hydrogen and air. Unfortunately, for the golf cart type vehicle, that is difficult because the hydrogen cannot be stored and thus must be generated as it is used. A golf cart does not have the size to accommodate hydrogen storage facilities such as found on the space shuttle rocket launcher and cars that are designed to burn hydrogen. The hydrogen source for the present invention is a hydrogen generator that produces hydrogen that is consumed almost immediately following production. The hydrogen generator takes a short period, such as 10 to 15 seconds, to come up to full production. It can be inconvenient to have to wait to start the engine until sufficient hydrogen is produced to run the engine and then wait a little longer to have full hydrogen production to run the golf cart. In addition, hydrogen generators, except during startup and shutdown, run at a constant rate. The hydrogen generator is not run like an electric motor or heat engine. It is either on or off. The hydrogen output can be controlled somewhat by a metering valve. In other words, hydrogen output to the heat engine can be reduced via metering valve. But this is for low speed control.

Preferably, the hydrogen is fed at a constant rate to have the engine run at 60 percent output. For greater output, gas is fed to the engine. For reduced power output for short periods, the hydrogen feed is reduced through a metering valve. Since hydrogen is produced at a constant rate by the generator, the metering valve if partially closed can cause back pressure to build up in the generator. The hydrogen generator has a pressure sensor. When the pressure reaches a predetermined value, the generator is turned off. When the pressure falls below a second predetermined pressure, the generator is turned back on.

There are variable output hydrogen generators normally employing a plurality of hydrolysis cells. The output of the generator is controlled by turning on or off one or more cells. The generator operation is controlled by a microprocessor which monitors the output of hydrogen and the need or requirement for hydrogen. Such variable output hydrogen generators are presently very expensive.

It is an object of the present invention to provide a hybrid type golf car type vehicle which can be powered either with a gasoline/hydrogen engine or with an electric motor. It is a further object to provide a vehicle that can go in a forward direction or in a reverse direction.

It is a further object of the present invention to provide a hybrid type golf car that operates on an electric motor when its battery has sufficient charge to operate the electric motor and which is operated with a gasoline/hydrogen engine which both operates, i.e. powers, the vehicle and charges the battery via a generator when the battery charge falls below a predetermined level, i.e. a low battery charge.

It is still another object of the present invention to provide a golf car that in the default mode operates with an electric motor either in the forward or reverse direction when the vehicle battery has sufficient charge, and operates with a gasoline/hydrogen engine in the forward direction and charges the vehicle battery when the vehicle battery charge falls below a predetermined level.

### SUMMARY OF THE INVENTION

The present is directed to a hybrid golf car type vehicle (also referred to as the “vehicle”) comprising a gasoline/hydrogen engine with on and off modes, the off mode being the default mode; a motor generator having a reversible motor mode and a generating mode, the motor mode in the forward direction being the default mode; a drive shaft connected to the motor generator, the motor generator driving the drive shaft in a forward or reverse direction when the motor generator is in the motor mode; a differential connected and driven by the drive shaft; two independent power axles connected to and driven by the differential; a directional drive train connecting the gasoline/hydrogen engine to the drive shaft, the engine driving the drive train and the drive shaft in the forward direction when the motor generator is in the generator mode, and the motor generator driving the drive shaft in the forward or reverse direction when the motor generator is in the motor mode; and a battery to power the motor generator in the motor mode, the motor generator charging the battery when the motor generator is in the generator mode and the drive shaft driven by the gasoline/hydrogen engine.

Preferably, the hybrid golf car type vehicle has a controller monitoring the voltage of the battery and adapted to automatically start the engine and switch the motor generator to the generator mode when the battery charge drops below a predetermined voltage.

In the preferred embodiment of the present invention, the hybrid golf car type vehicle includes a reversing switch adapted when activated to stop the engine, if running, switch the motor generator to the motor mode, if in the generator mode, and switch the motor generator to a reverse direction, the reversing switch being normally off when not activated.

In a preferred embodiment of the present invention, a hybrid golf car type vehicle includes an on/off switch to turn on or turn off the vehicle automatic operation. The vehicle automatic operation when activated turns on the motor generator in the motor mode in a forward direction when the battery charge is at least equal to a predetermined voltage, or starts the hydrogen generator and the engine when the battery charge is less than the predetermined voltage and switches the motor generator to the generating mode. When the on/off switch is turned off, it turns off the motor generator, the engine, and hydrogen generator. Preferably, the on/off switch is connected to the controller, which has a microprocessor, and the controller carries out the vehicle automatic operation.

In another preferred embodiment of the present invention, the hybrid golf car type vehicle includes a manual override switch to override the vehicle automatic operation. The manual override switch can be activated to a first on mode which turns off the engine and the hydrogen generator if running and switches the motor generator from a generator mode to a motor mode in the forward direction regardless of the battery charge. Preferably the manual override switch can be activated to a second on mode which switches the motor generator from the motor mode to the generator mode and turns on the engine and the hydrogen generator regardless of the battery charge. Preferably, the manual override switch is connected to the controller and the controller overrides the vehicle automatic operation when the vehicle is switched to manual operation.

In a preferred embodiment of the present invention, the hybrid golf car type vehicle has an accelerator to control the power or rpm's of the motor generator when the motor generator is in the motor mode and to control the power or rpm's of the engine when the engine is turned on. Preferably, the accelerator is directly connected to the controller and the controller controls the power of the motor generator in the motor mode and the engine when running in response to signals from the accelerator.

The present invention is directed to a hybrid golf car type vehicle comprising a gasoline engine with on and off modes, the off mode being the default mode; a motor operable in a forward or reverse direction, the motor in the forward direction being the default mode; a drive shaft connected to the motor, the motor driving the drive shaft in a forward or reverse direction; a differential connected and driven by the drive shaft; two independent power axles connected to and driven by the differential; a directional drive train connecting the engine to the drive shaft, the engine driving the drive train and the drive shaft in the forward direction when the motor is not powered, and the motor driving the drive shaft in the forward or reverse direction when the motor is powered and the engine is turned off; a battery to power the motor; and a charger to charge the battery when the engine is driving the drive shaft, a hydrogen generator turned on when the engine is on and turned off when the engine is off, the hydrogen generator supplying hydrogen to the engine.

Preferably, the hybrid golf car type vehicle has a controller monitoring the voltage of the battery and adapted to starting the engine and hydrogen generator and turning off the motor when the vehicle is in the automatic on mode and the battery charge drops below a predetermined voltage.

In the preferred embodiment of the present invention, the hybrid golf car type vehicle includes a reversing switch to reverse direction of the vehicle which when activated (1) reverses the motor if operating in the electric motor mode, or turns off the engine and hydrogen generator, and switches on the motor in the reverse direction in the motor mode. The reversing switch being off when not activated. Preferably, the reversing switch is connected to the controller and the controller controls the reversing operation of the vehicle.

In a preferred embodiment of the present invention, a hybrid golf car type vehicle includes an on/off switch to turn on or turn off the vehicle automatic operation which turns on the motor in a forward direction when the battery charge at least equals a predetermined voltage, or starts the engine and the hydrogen generator and turns off the motor when the battery charge is less than the predetermined voltage, and which when turned off, turns off the motor and the engine. The motor is turned off or deactivated by cutting off electrical power, i.e. the ignition, to the motor. The engine and hydrogen generator are turned off by deactivating the engine control which deactivates the engine and the hydrogen generator control. The default modes for the engine and hydrogen generator is the off mode.

In another preferred embodiment of the present invention, the hybrid golf car type vehicle includes a manual override switch to override the vehicle automatic operation. The manual override switch can be activated to an electric motor on mode which turns off the engine and hydrogen generator, and turns on the motor in the forward direction regardless of the battery charge. Preferably the manual override switch can also be activated to an engine on mode which turns off the motor and turns on the engine and the hydrogen generator regardless of the battery charge. An overcharge of the battery is prevented by a voltage regulator. Preferably, the manual override switch is connected to the controller which then controls the override over the vehicle automatic operation.

As mentioned above, the hydrogen input to the motor is steady state but can be controlled to some extent by metering with a metering valve.

The metering valve is an electrically controlled valve that is closed in its default mode. The valve must be powered up to open and to control its metering. The metering valve will normally be fully open when the vehicle is in the cruising mode. The hydrogen is fed directly from the hydrogen generator into the air intake of the engine. The air in the air intake is normally very turbulent and the hydrogen is rapidly distributed into the intake air by the time the hydrogen/air mixture reaches the cylinders. Gasoline, as needed, is introduced into the intake air in a carburetor throat or into the hydrogen/air mixture in the cylinders by fuel injection. In some engines, the gasoline is introduced into the intake air or hydrogen/air mixture in the intake manifold.

Preferably, the gasoline will be metered for acceleration, high speed, and rapid deceleration. The hydrogen generator will normally be a constant output generator with the normal output designed to run the engine at its designed cruise speed (about 10 to about 30 mph for the golf cart vehicle with the generator on). For brief idling or brief periods of slow driving, the hydrogen generator output can be metered back. For long periods of idling, or slow driving, the hydrogen generator will be shut down to prevent pressure build up in the hydrogen generator. Preferably, the hydrogen generator has a pressure sensor which signals the controller when pressure has built up in the generator to turn off the generator.

In a preferred embodiment of the present invention, the hybrid golf car type vehicle has an accelerator to control the power of the motor when it is turned on or to control the power of the engine when it is operating. Preferably, the accelerator is connected to the controller which controls the power of the motor or engine and the hydrogen from the hydrogen generator by controlling the metering valve or the hydrogen production by controlling the voltage input to the hydrogen generator in response to the signals from the accelerator.

When the motor is on or powered, the engine and hydrogen generator are off, and when the engine is on or operating, the hydrogen generator is normally on and the motor is turned off. The motor and engine are never on simultaneously. When the engine is off, the hydrogen generator is off.

In the preferred embodiment of the present invention, the on/off switch is directly connected to the controller.

In the preferred embodiment of the present invention, the reverse switch is connected directly to the controller and the controller carries out the reversal operation of the vehicle and the controller reverses direction of the vehicle.

In the preferred embodiment of the present invention, the manual override switch is connected directly to the controller and the controller carries out the manual motor mode or the manual engine mode of operation.

In another preferred embodiment of the present invention, the accelerator is connected directly to the controller and the controller controls the power of the motor, or the motor generator when the motor generator is in the motor mode, and controls the power of the engine when the engine is on.

In the preferred embodiment of the present invention, the hybrid golf car type vehicle has an electric starter motor to start the engine. The on/off switch is connected to the started motor usually via the controller which activates the starter motor for a predetermined time to start up the engine. In a preferred embodiment of the present invention, the starter motor is connected directly to the controller and the controller activates the starter motor for a predetermined time to start the engine. Preferably, the controller monitors the on/off status of the engine and activates the starter motor when the vehicle on/off switch is turned on and the battery charge is below a predetermined value or the manual override switch is activated to operate the engine until the engine starts. The controller also controls the on/off operation of the hydrogen generator.

The controller comprises a number of control elements including a motor control, an engine control, a charger control, a hydrogen generator control, a metering valve control, and the like, and monitors the status of the battery charge, the engine on/off status, the hydrogen generator on/off status, and the like. The control system can be combined in a single microprocessor or in two or more microprocessors.

### BRIEF DESCRIPTION OF THE DRAWING

FIG. 1 is a symbolic representation of the layout of the hybrid golf type vehicle of the present invention;

FIG. 1A is virtually identical to FIG. 1 but illustrates another embodiment of the hybrid golf car type vehicle of the present invention;

FIG. 2 is a flow chart illustrating the operation of the hybrid golf car type vehicle system of the present invention for the vehicles of FIGS. 1 and 4;

FIG. 2A is a flow chart illustrating the operation of the hybrid golf car type vehicle system of the present invention for the vehicles of FIGS. 1A and 4A;

FIG. 3 is a flow chart of the operation commands of the present invention for the vehicles of FIGS. 1 and 4;

FIG. 3A is a flow chart of the operation commands of the present invention for the vehicles of FIGS. 1A and 4A;

FIG. 4 is similar to FIG. 1 and illustrates another embodiment of the hybrid golf car type vehicle of the present invention; and

FIG. 4A is virtually identical to FIG. 4 but illustrates another embodiment of the hybrid golf car type vehicle of the present invention;

### DETAILED DESCRIPTION OF THE INVENTION

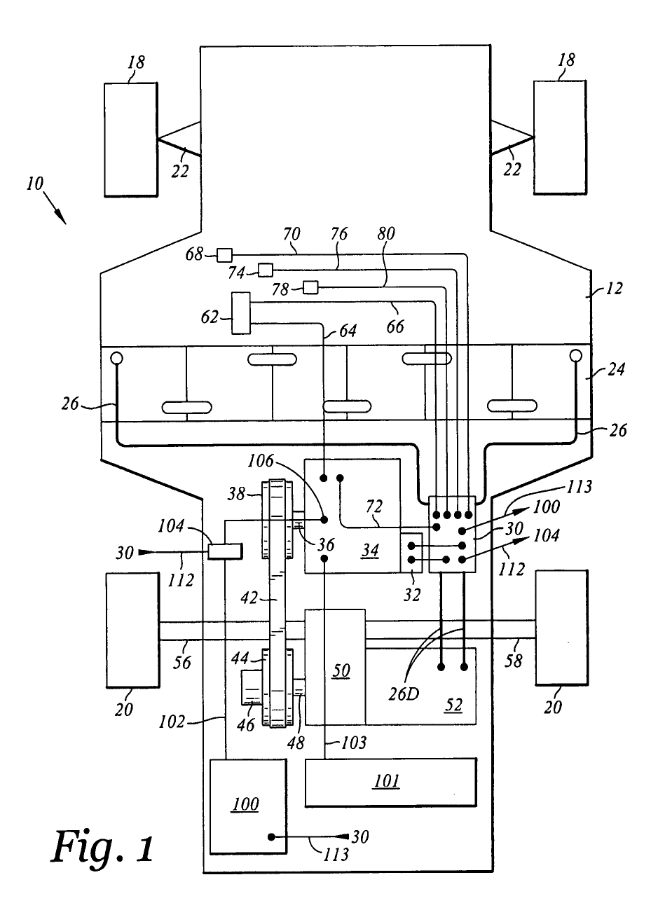

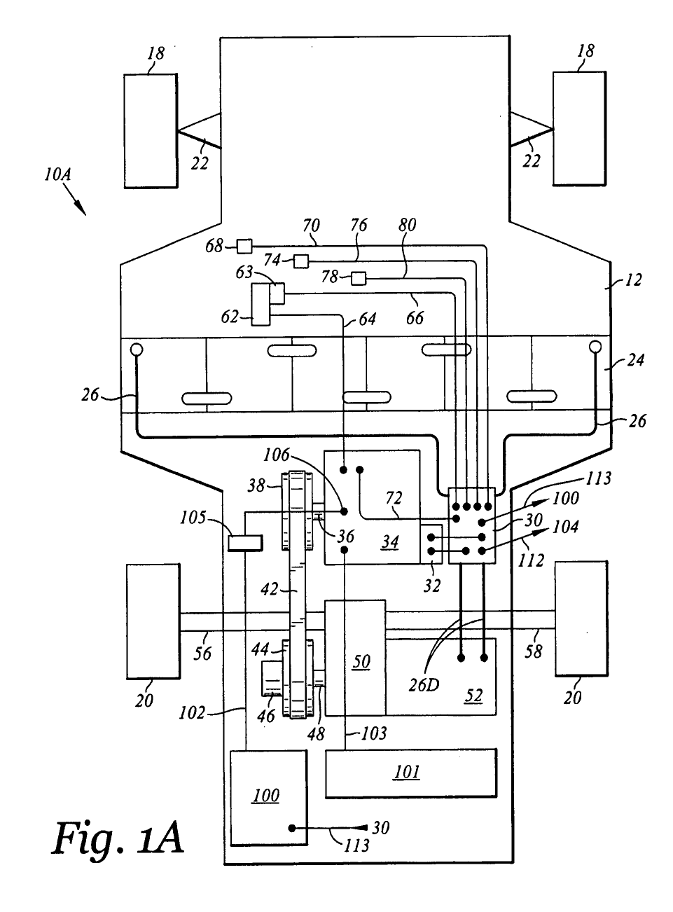

Referring to FIG. 1, the hybrid golf car type vehicle 10 of the present invention has a frame 12 with front wheels 18 supported by suspension 22 and rear drive wheels 20 driven by drive axles 56A and 56b, respectively. A battery pack 24 (“battery” herein) is situated on the frame and is connected to a control box 30 via battery cables 26 which extend to a motor generator 52 through battery cables 26D. Most golf cart type vehicles 10 operate on nominal 48-volt systems using an array of six 8-volt batteries connected in series. The controller or control box 30 contains a microprocessor and switch controls and it controls operation of the vehicle. The controller or control box 30 can be made up of several separate independent components, such as a motor control, engine control, hydrogen generator control, and the like, that are not combined in one unit. For ease in describing the invention in this figure, the controls have collectively been referred as the control box 30. The control box has leads to starter 32. The starter 32 is electrically powered and is used to start the gasoline engine 34. An engine status sensor (not shown) on the engine is connected to the control box and the control box monitors the on/off status of the engine. The sensor can measure intake manifold pressure or engine rpm's to determine if the engine is on.

When the control box 30 via the engine status sensor detects that the engine is off, it turns the hydrogen generator 100 off by cutting electrical power to the generator as described below unless the vehicle is in the startup mode. When the on/off switch 68 is first turned on, it sends a command signal to the control box to start the engine. The control box, when it receives that command, turns on the hydrogen generator by powering up the generator with electrical power as described below even though the engine is in the startup mode and still not running or on. The control box is programmed to rerun the starter procedure until the engine starts or the on/off switch 68 is turned off. However, the system can have a limiter programmed into the control box to limit the number of starter repeats to prevent burn out of the starter motor.

The engine drive shaft 36 extends out of the left side of the engine and a torque converter/centrifugal pulley 38 is mounted thereon. An endless belt 42 is fitted to the pulley and the other end of the endless belt is connected to a second torque converter/centrifugal pulley 44. Centrifugal pulleys 44 and 38 have reverse actions. As pulley 38 increases in rpm, the effective pulley diameter increases. As centrifugal pulley 44 increases in rpm, the effective pulley diameter is reduced. A sprag clutch 46 rides on drive shaft 48 and is connected to pulley 44. Pulley 44 through sprag clutch 46 engages the drive shaft 48 which extends through differential 50 and extends to the motor shaft (not shown) of the motor generator 52. The drive axles 56A and 56B, for the wheels 20, are also connected to the differential 50 and are driven by the differential. The differential in turn is driven by shaft 48 and either driven by motor generator 52 or engine 34 as described herein.

The motor generator 52 in the motor mode drives shaft 48, but it does not drive centrifugal pulley 44 because the sprag clutch does not engage shaft 48 when shaft 48 is being driven by the motor generator. When the engine 34 is operating, the gas engine drives centrifugal pulley 38 and endless belt 42 which in turn drives pulley 44. In that mode of operation, the sprag clutch 46 connected to pulley 44 engages and drives drive shaft 48. This in turn drives the differential 50 and drives the drive axles 56A and 56B. In other words, shaft 48 when powered by the motor generator cannot engage sprag clutch 46 to turn pulley 44. However, when pulley 44 is turned by endless belt 42, the sprag clutch 46 engages and drives shaft 48.

For operation, the on/off switch 68 is turned on and sends a signal via line 70 to the control box 30. The control box monitors the voltage of the battery continuously when it is on. If the battery is above a threshold voltage, about 35 volts, the controller when the on/off switch is turned on, activates vehicle operation by powering the motor generator in the motor mode. If the control box determines that the voltage is above 35 volts for the battery 24, it will not start the engine 34 or power up the hydrogen generator 100. It will let the vehicle operate in the automatic motor mode described below. If the control box determines that the voltage is below 35 volts for the battery, then it starts the engine 34 by activating starter 32 and starts the hydrogen generator 100 by supply electrical power via line 113 and the vehicle will operate in the automatic engine mode. In addition, it opens metering valve 104 via signal 112 to feed hydrogen into the engine air inlet 106. The starter 32 operates for a predetermined period and then stops by control box 30 even if the engine failed to start to prevent the starter from being burned out. The hydrogen generator can also be turned off by the control box 30 if the engine does not start. The control box via the status sensor on the engine (not shown) will determine if the engine is started and running. If the engine has not started, after a predetermined second period, the control box will again activate the starter 32, turn on the hydrogen generator 100, and open the metering valve 104, and repeat the above process until the engine starts. The same operation is carried out (1) in the manual override modes described herein and when, (2) during vehicle automatic operation when the battery falls below about 35 volts, or (3) when the vehicle has been in the reverse mode and the reverse switch is turned off and the vehicle returns to automatic operation or manual operation.

The vehicle is fitted with a manual override switch 74 which has two different on modes or settings. Thus, the manual override switch can either be off or it can be on, in one of two on modes. In the first on mode, the engine mode, the manual override switch 74 sends a signal via line 76 to control box 30 to start the engine 34 and turn on the hydrogen generator 100 for operation of the vehicle with the engine. The control box 30 will start the engine, turn on the hydrogen generator, open the metering valve 104 and switch the motor generator from the motor mode to the generator mode or switch the motor generator off if the battery is fully charged. In the second on mode, the motor mode, the control box will not activate the engine 44 or hydrogen generator 100, rather it will have the vehicle operated in the electric motor mode employing the motor generator in the motor mode and kill or turn off the engine and turn off the hydrogen generator.

The vehicle is also fitted with a reverse switch 78 connected to the control box via a line 80. When the reverse switch 78 is activated, it sends a signal 80 to the control box 30 which overrides all other signals being sent to the control box if other signals are being sent to the control box. When the reverse switch is activated or turned on, the control box kills the ignition or stops the engine 34 if it is operating, turns off the hydrogen generator 100, closes the metering valve 104, and switches operation of the motor generator from the generating mode, if it is operating in that mode, to the motor mode in the reverse direction. This permits the vehicle to be reversed or backed up when the situation requires it. When the reverse switch is turned off, the control box will return to its previous mode of operation depending upon whether automatic operation has been activated, or manual override operation, or off. The ability to reverse the vehicle is an important element or benefit of the present invention. In order to accomplish this, the battery 24 cannot be allowed to be completely discharged. For that reason, a threshold voltage has been set around 35 volts. The battery, when fully charged, is about 48 volts. When the battery pack voltage falls below about 35 volts, the control box 30, in automatic operation, will automatically start up the gasoline engine and turn on the hydrogen generator and open the metering valve, and convert the motor generator from the motor mode to a generating mode. Manual override can override this automatic operation, but if the voltage of the battery is below 35 volts, a warning signal will be given by an alarm (not shown). The alarm can be either an optical alarm, such as a flashing light, and/or a sound alarm. If the batteries are fully charged, the controller, which monitors the battery charge status, will start the engine but the battery will not be charged to prevent over-charging the battery. When the battery has been fully charged by the engine, i.e. the battery is about 48 volts, the controller in the automatic mode turns off the engine and turns on the motor generator in the motor mode. A fully charged battery does not exceed 50 volts.

During operation of the vehicle, either in the automatic mode or the manual mode, or the reverse mode, the speed of the vehicle is controlled by an accelerator 62. Accelerator 62 sends out a power control signal 66 to the control box 30 and optionally a signal 64 to the engine 34. Optionally, the power control signal 66 can be sent to the controller and the controller then sends power control signals to the motor or engine. Depending upon the operation mode, the accelerator will either directly or indirectly control the speed of the engine 34 or the speed of the motor 52. The engine and the motor generator in the motor mode do not operate simultaneously in any mode of operation. Thus, if the motor is on, the engine is off and vice versa.

In operation, most of the time, the system will be operated in the automatic mode controlled by the microprocessor in control box 30. The vehicle will be turned on by on/off switch 68. The control box or controller 30 will monitor the voltage of the battery 24 and if the battery 24 is above the threshold voltage, it will operate the vehicle with the motor generator 52 in the motor mode. The default mode for motor generator 52 is the motor mode, and the engine 34 will not be started and the hydrogen generator will not be turned on. Motor generator 52, the speed of which will be controlled by accelerator 62, drives shaft 48 which drives the differential 50 which in turn drives the power axles 56 and 58 and the wheels 20. If the voltage of the battery 24 is below the threshold 35 volt voltage, the control box 30 will start up the engine 34 by a signal 72 and turn on the hydrogen generator 100 and open the metering valve 104. It will shift the operating mode of motor generator 52 into the generating mode. Engine 34 turns shaft 36 and pulley 38. Pulley 38 drives endless belt 42 which drives pulley 44. Sprag clutch 46 when driven by pulley 44 engages shaft 48 which drives differential 50 and drives the motor generator 52 in the generating mode. The drive axles 56 and 58 are driven by the differential. The current generated by the motor generator is used to charge the battery 24 via power cable 26. Preferably the charging system incorporates a regulator to prevent overcharging the battery.

If the operator of the vehicle comes to a situation where he or she has to back up, the operator will activate reversing switch 78, in other words turn it on, which sends a signal to control box 30. If the vehicle is already in the motor mode, the control box reverses the polarity to the motor generator 52 reversing direction of the motor generator which reverses direction of the differential and the drive axles 56 and 58 to reverse the vehicle. If the vehicle is operating in the engine mode, control box 30 kills the ignition of the engine 34, turns off the hydrogen generator 100, closes metering valve 104, and switches the operating mode of the motor generator 52 to the motor mode in the reverse direction. Since the battery 24 is never fully discharged, there is sufficient current to power motor 52 in the reverse direction, at least for a limited distance and for a limited time. After the back up operation has been made, and the reverse switch turned off, the vehicle returns back to its mode of operation before activation of the reverse switch. As mentioned above, when the motor generator is operating in the motor mode and driving shaft 48 in the forward direction or the reverse direction, sprag clutch 46 does not engage shaft 48 and thus pulley 44 is not turned by shaft 48 being driven by the motor generator.

As mentioned above, the manual override switch has two modes of on operation, a manual engine on mode with engine on, and a manual motor on mode with motor on. The default is to have the manual override switch off. If the vehicle is in the engine mode, the manual override switch can be utilized to convert operation from the engine mode to the motor mode. If the vehicle is in the motor mode, the manual override switch can be utilized to convert operation of the vehicle to the engine mode. The engine mode can be useful when greater speeds are required, or if the vehicle is going to be driven a substantial distance which will exhaust the battery.

Preferably, the feed line 102 from the hydrogen generator to the engine has a check valve 105 to prevent air backflow in the line 102. Gasoline is fed from tank 101 via line 103 to the engine 34.

Referring to FIG. 1A, FIG. 1A illustrates another embodiment of the hybrid golf vehicle of the present invention. For those components that are identical to the components shown for the vehicle in FIG. 1, the same numbers are used and it is not required to redescribe them here. The vehicle 10A of FIG. 1A does not utilize a metering valve 104 to control the hydrogen flow, but rather it controls the hydrogen output fed to the engine 34 by controlling the voltage fed to the hydrogen generator 100 via the controller or control box 30 and a voltage regulator 63 attached or connected mechanically or electronically to the accelerator 62. The voltage regulator 63 is controlled by and is responsive to the accelerator 62. For example, when the accelerator pedal is not engaged, and the engine is at idle, the voltage to the hydrogen generator 100 is at a low level just sufficient to produce hydrogen to keep the engine operating in an idle condition. When the throttle is engaged, the voltage controller 63 responds to the throttle and increases the voltage to the hydrogen generator to produce more hydrogen to speed up or accelerate the engine. Since the hydrogen output is directly controlled in this embodiment, there is no requirement for a needle valve. When the engine is off and/or the on/off switch is off, controller 30 cuts off all electrical power to the hydrogen generator and the accelerator 62 via the voltage controller 63 has no control at that point over the hydrogen generator.

In all other respects, the hybrid golf car type vehicle 10A and its operation are identical to the hybrid golf car type vehicle 10 of FIG. 1 and its operation.

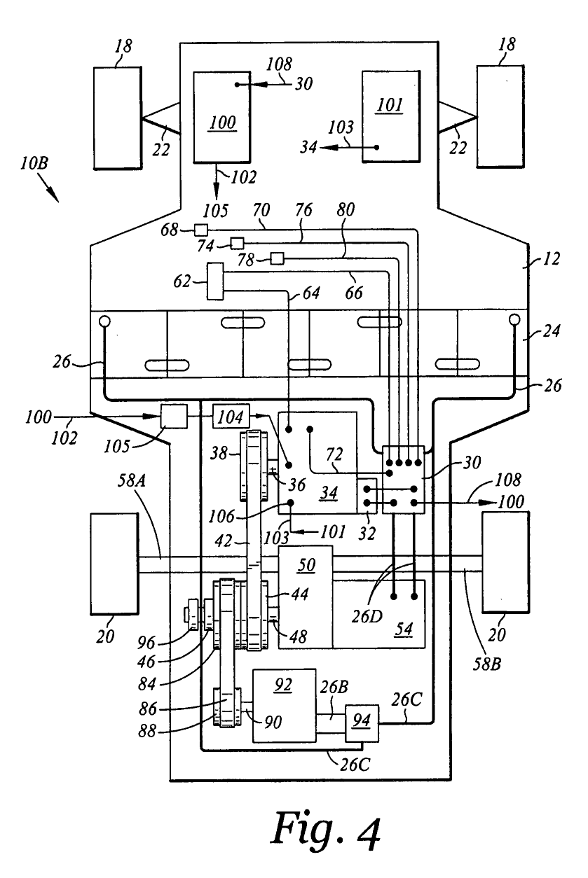

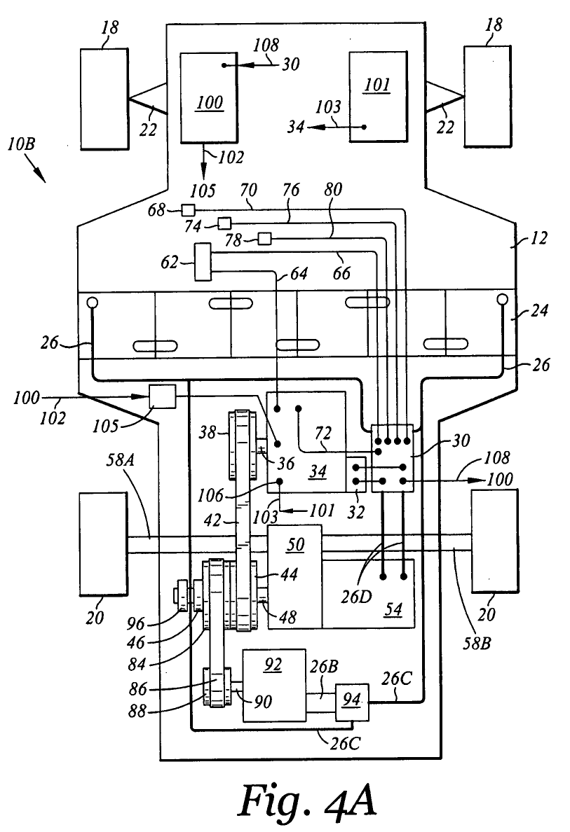

Referring to FIG. 4, FIG. 4 illustrates another embodiment of the hybrid golf car vehicle 10B of the present invention. For those components that are identical to the components shown for the vehicle in FIG. 1, the same numbers are used and it is not required to redescribe them here. The vehicle 10B of FIG. 4 does not utilize a reversible motor generator 52, but rather it utilizes an electric motor 54 which is reversible. The operation of vehicles 10 and 10B are identical with regard to turning on and off employing the manual override switches, activating the reverse switch, and using the accelerator. The difference between the two vehicles is that vehicle 10 employs a motor generator 52 whereas vehicle 10B employs an electric motor 54 and a separate charger 92, preferably a permanent magnet alternator (PMA). A generator can be used in place of an alternator, but a PMA is preferred. Shaft 48 in vehicle 10B is extended farther out to receive a second pulley 84 which is connected to pulley 88 by endless belt 86. Pulley 88 is connected to shaft 90 which extends out from alternator 92. The sprag clutch 46 operates in the same manner that the sprag clutch 46 operates in vehicle 10. However, sprag clutch is connected to both pulleys 84 and 44 and sprag clutch only engages shaft 48 when pulley 44 is being driven by engine 34 as explained above. In vehicle 10B when electric motor 54 is operated, the shaft 48 does not engage sprag clutch 46 and pulleys 84 and 44 are not turned when the shaft 48 turns. However when engine 34 is operated and endless belt 42 rotates pulley 44, sprag clutch 46 is engaged and engages shaft 48 to turn differential 50 and rotate pulleys 44 and 84. Preferably, the end of shaft 48 is supported by a bearing 96 because of its length. Bearing 96 may be eliminated if shaft 48 is robust enough to prevent bending motions and the bearing in the differential can support the radial forces on the shaft. The current from the charger 92, which is powered by the engine 34 via pulleys 38, 44, 84, and 88, and belts 42 and 86, is fed via a voltage regulator 94 via lines or cables 26D to the control box 30. The output from the voltage regulator 94 is fed to battery 24 via battery cables 26. The hydrogen generator is operated in the same manner as described above for vehicle 10.

Referring to FIG. 4A, FIG. 4A illustrates still another embodiment of the hybrid golf car type vehicle 10C of the present invention. For those components that are identical to the components shown for the vehicle in FIGS. 1 and 4, the same numbers are used and does not require to redescribe them here. The vehicle 10C of FIG. 4A does not utilize a metering valve 104 such as used in vehicles 10 and 10B of FIGS. 1 and 4, respectively. The vehicle 10C utilizes direct control of the hydrogen feed via the accelerator 62 in the same manner as vehicle 10B of FIG. 1A. A voltage controller 63 is controlled by the accelerator 62 and is mechanically or electronically connected to accelerator 62. The voltage controller 63 via controller 30 controls the voltage input into the hydrogen generator 100 via line 66 and power conduit 108 from controller 30. Direct current having a voltage from 0 up to 50 volts can be fed to the hydrogen generator 100. The voltage supplied to the hydrogen generator is controlled by the throttle 62 via the voltage controller 63 as described above with respect to vehicle 10A of FIG. 1A. When the hydrogen output is controlled by voltage control, it is not necessary to have a metering valve 105 to control the hydrogen through the feed line 102 to the engine 34. Operation of the voltage controller 63 and the operation of the hydrogen generator is as described herein.

Referring to FIGS. 1, 1A, 4, and 4A, the sprag clutch transmits power to the drive shaft but not vice versa. Thus, when the vehicle is being operated with the gas engine, the sprag clutch 48 connected to pulley 44 engages shaft 48 and drives the motor generator in the generating mode and drives the vehicle through differential 50. However when the gasoline engine has ignition off, the drive shaft 48 is driven by the motor 54, or by the motor generator 52 in the motor mode, through differential 50. In this mode the sprag clutch will not engage shaft 48 and pulley 44 will not be driven by shaft 48.

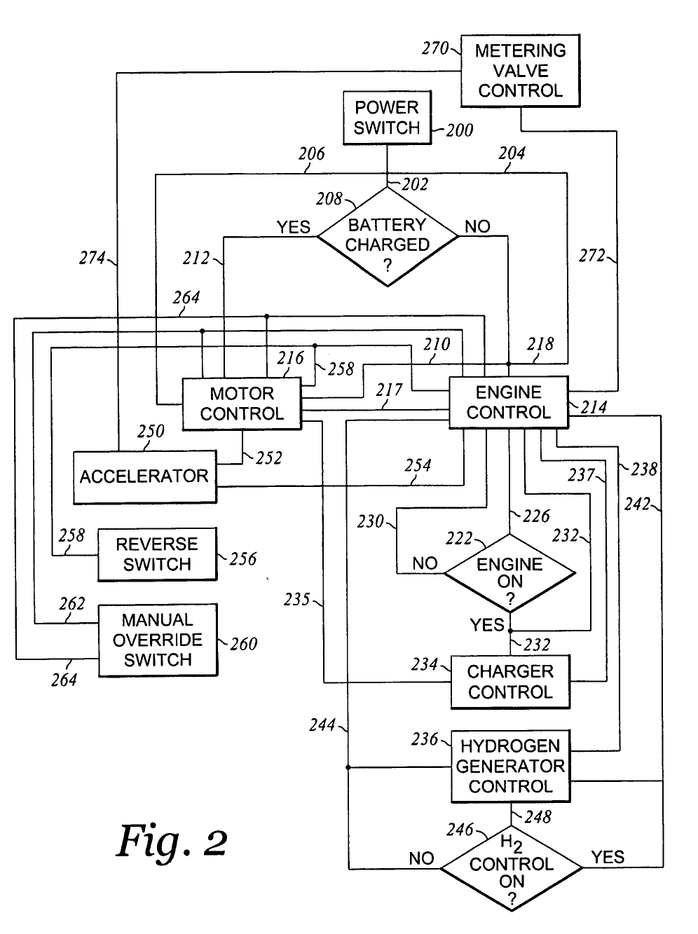

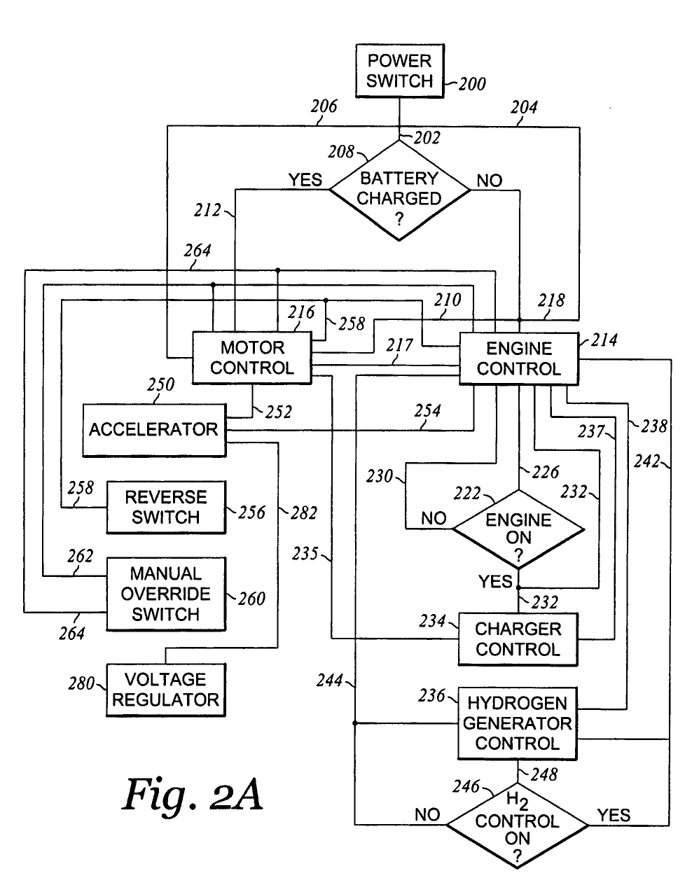

Referring to FIGS. 2 and 2A, a diagram showing the preferred control system of the hybrid golf vehicles is illustrated.

When the vehicle power switch 200 is off, the electric motor, gasoline engine and hydrogen generator are off and there is no power draw on the battery. In the preferred embodiment, the microprocessor which is collectively shown in FIG. 2, continually monitors the battery status and preferably gives an alarm, visual and/or audio, if the battery voltage drops below a predetermined voltage which indicates a weak battery charge.

Several of the components of the vehicle control system have default modes and only remain in the default mode until they receive a signal to switch to and operate in another mode. They remain in the other mode as long as they receive the signal. When the signal stops, the components revert back to their default mode. For example, a component that is normally off—the default mode—will only be on or activated if it continuously receives the on or activation signal. When it ceases to receive the signal, the component will automatically revert back to the default mode and shut off. The reversion to the default may be delayed a predetermined time, such as one second, after it ceases receiving the on or activation signal. This may be for safety reasons in some cases and/or for reasons of proper operation in other cases.

The default mode for the electric motor or motor generator, engine, the hydrogen generator, and the metering valve when the power switch is on and the battery is sufficiently charged is: motor on, engine off, hydrogen generator off, and metering valve off, if present, closed. The default mode for the motor or motor generator, the engine, the hydrogen generator, and the metering valve when the power switch is on and the battery is not sufficiently charged is: motor off, engine on, charger mode on for a motor generator, hydrogen generator on, and metering valve, if present, on or open. When the power switch 100 is off, the default modes for the motor, engine, hydrogen generator are off and the metering valve, if present, is closed. The motor or motor generator, the engine, the hydrogen generator are not shown in FIG. 2; they are shown in FIGS. 1 and 4. When the power switch 200 is turned on, the charge status of the battery 208 is checked via interrogation signal 202. If the battery is not sufficiently charged, a signal 210 is sent from the battery charge status 208 to engine control 214 commanding start up of the gasoline engine (not shown). The engine control commands the startup of the hydrogen generator (not shown) via signal 238 to hydrogen generator control 236. The hydrogen generator remains on as long as it receives an on signal from the hydrogen generator control 236. If the signal stops, the hydrogen generator reverts to its default mode, the off mode. The default mode for the hydrogen generator control is the off mode, and in the off mode, it does not signal the hydrogen generator to the on mode. The default mode for the hydrogen generator is off. The engine control 214 interrogates the on/off status of the engine 222 via signal 226. If the engine is off, the engine control receives “no” or off signal 230, and the engine control ceases signaling to the hydrogen generator control 236 to turn on the hydrogen generator which in turn then ceases signaling the on mode signal to the hydrogen generator. The hydrogen generator then reverts back to its default off mode. This ensures that the hydrogen generator will not be on when the engine is off except in the engine startup mode. When the engine is being started up, the engine control 214 sends a signal 272 to the metering valve control 270 for hydrogen flow if a metering valve is present as in vehicle 10 and 10B. When the engine is on, the engine control 214 turns the metering valve on via on signal 272 and metering valve control 270.

The engine control repeatedly sends the signal 272 to the metering valve control 270 to keep the metering valve open when the engine is on. The default mode for the metering valve control 270 and the metering valve (not shown) is off which causes the valve to close. When the metering valve is on, its control of hydrogen flow through the valve can be controlled by the accelerator 250 via the engine control. When the engine is off, the engine control and the metering valve revert to their off default modes. The default mode of the metering valve is the closed mode to prevent hydrogen from leaking out and oxygen leaking into the hydrogen line and the hydrogen generator when the engine is off.

The low battery charge signal 210 is also sent to the motor control 216 which causes the partial deactivation of the motor control. The battery charge 208 is periodically checked by interrogation signal 202. Motor control 216 interrogates the engine control 214 via signal 217 to determine the engine status (on or off). The engine control 214 interrogates the engine status 222 via signal 226. If the engine is running, a signal 230 is sent to the engine control which sends a signal 237 to the charger control 234 to switch the motor generator if the system has a motor generator to the generator mode. The charger control 234 commands the motor generator via signal 235 and motor control 216 to operate in the charging mode. The default mode for the motor charger is the motor mode. Optionally, the charger control can directly control the generator operation of the motor generator without directing the motor control to control the generator operation. The charger control 234 controls the charger operation of the motor generator. If a motor and separate alternator or generator are used (FIGS. 4 and 4A), a charger control can be optional. The status of the engine 222 is sent via signals 230 or 232 to the engine control 214. If the engine is off, the engine control attempts to restart the engine and to turn on the hydrogen generator via signal 238 and hydrogen generator control 236. This is repeated until the engine starts.

If the battery has sufficient charge, a signal 212 is sent to the motor control 216 fully activating the motor control. The motor control controls the modes of the electric motor or motor generator among other things. The accelerator or throttle 250 for the hybrid utility runabout is connected to the motor control 216 and to the engine control 214 via signals 252 and 254, respectively.

When the battery does not have a sufficient charge, the engine control becomes operational via signal 210 from the battery status 208. When the battery has sufficient charge, the motor control 216 becomes operational. Thus, when the vehicle is on and the battery is charged, the engine control is off by default, except for manual override described below, and the engine and hydrogen generator are in the off mode by default. When the vehicle is on and the battery charge is low, the engine control is operational and the motor control is partially operational to put the motor charger into the charger mode. The exception is manual operation and reversal of the vehicle as described below. Thus, the accelerator 250 usually operates through the engine control 214 when the engine control is activated which usually only happens when the battery charge is low. In contrast, when there is sufficient battery charge, the accelerator usually operates through the motor control 216 when the motor control is fully activated and the engine control is deactivated by the signal 210.

When the hybrid utility runabout has to be reversed, it is reversed by the motor or the motor generator in the motor mode and not by the gasoline engine. The system is designed never to fully exhaust the batteries. The battery status sensor 208 signals whether the battery is charged below or above about 35 volts for a nominal 48-volt battery system for low battery charge or sufficient battery charge, respectively. When the voltage of the batteries drops below 35 volts, the engine control 214 receives the voltage status signal 210 from battery status 208, and the engine control becomes operation and activated, and the motor control receives the same signal and becomes partially deactivated. When the battery charge is 35 volts or more, the engine control is deactivated and reverts to its default mode. When the power switch is on, the motor control is either fully on or activated (default mode) or partially on when the battery does not have sufficient charge. The motor control remains partially on to switch the motor generator to the generator mode.

When the vehicle must be reversed, the reverse switch 256 is activated and the reverse signal 258 is sent to the motor control 216 activating the motor control for reverse movement. The signal 258 is also sent to the engine control 214 deactivating the engine control 214 which in turn kills the engine (engine default mode) as explained above and deactivates the hydrogen generator control and the metering valve control 270 which deactivates the hydrogen generator (default mode) and deactivates and closes the metering valve (default mode). Normally, a reverse operation is only for very short distances and for very brief period of time and a weak battery charge can handle the operation.

The manual override switch 260 permits operation of either the gasoline engine or the motor or motor generator. The override switch 260 if switched to the manual motor mode, sends signal 264 to the motor control 216 and the engine control 214 fully activating the motor control 216 and deactivating the engine control 214. If on the other hand the operator wishes to operate the vehicle with the gasoline engine, the switch 260 is switched to the manual engine mode and signal 262 is sent to the engine control 214 activating the engine control and to the motor control 216 partially deactivating the motor control. The reverse switch 256 overrides the manual override switch 260 and automatic operation of the vehicle and deactivates the motor mode of motor control.

The power or on/off switch 200 when turned on sends a signal 206 to the motor control 216 to fully activate it assuming there is sufficient battery charge. If the charge is insufficient, signal 210 overrides signal 206. The accelerator 250 sends a signal 252 to the motor control to control the power output of the motor when the motor control is fully activated. The accelerator 250 sends a signal 254 to the engine control 214 to control the power output of the engine when the engine is control is activated. The signal 252 controls the power of the motor or the motor generator in the motor mode. If the motor generator is in the generating mode and the engine is on, the signal 254 from the accelerator 250 controls the power output of the engine.

When the battery charge is below a predetermined voltage at startup, the signal 210 activates the engine control 214. The engine control signals the engine for startup and signals the hydrogen generator control 236, as described above, which then turns on the hydrogen generator. The engine control 214 also activates the metering valve control 270 causing the valve to open. As stated herein, the engine control will repeatedly attempt to start the engine until it starts. The engine control 214 continually monitors the status of the engine by interrogating sensor 222. In the startup phase of the engine, the engine status 222 can be interrogated frequently, such as 10 times a second. The engine status 222 sends the yes or no signals 230 or 232 to the engine control 214 regarding the on/off status of the engine. If the engine does not start after initiating of the engine startup after a predetermined period of time, the engine control will initiate the starting operation again until such time as the engine is operating. During the startup phase, the hydrogen generator can remain on and the meter valve can remain open, or the engine control can be programmed to shut it down between startup attempts until the engine is running. When the engine is on, i.e. running, a signal 232 is sent to the charger control 234, if present, which signals the motor control 216 to switch operation of the motor generator from the motor mode to the charging mode. A charger control is not required when a separate alternator or generator is utilized rather than a motor generator to change the batteries.

In a preferred embodiment of the present invention, the hydrogen generator control 236 monitors or interrogates the on/off status 246 of the hydrogen generator via signal 248. The status sensor 246 sends the appropriate signal 242 or 244 to the hydrogen generator control 236 and the engine control 214. If the hydrogen generator is on, the engine control will confirm that the engine is running via status sensor 222. If the engine is not running (signal 230), the engine control will deactivate the hydrogen generator control 236 by stop signaling (signal 238) to turn the hydrogen generator on. If the hydrogen generator is not on, and the engine is running, the engine control will activate the hydrogen generator control via signal 238 after receiving signal 244 from the hydrogen generator status 246. If, and only if, the hydrogen generator control 236 receives activation signal 238 from the engine control, will it turn on the hydrogen generator. If the hydrogen generator does not turn on and the sensor 246 sends signal 244 to the hydrogen generator control, the hydrogen generator control can optionally send an alarm signal to an audio transducer (not shown) and/or visual signal (not shown), such as an LED, to advise that the hydrogen generator is not functioning. In addition, if the hydrogen generator sensor 246 signals that the hydrogen generator is not on (signal 244) after a predetermined period, such as about 10 seconds, the engine control 214 will feed the engine additional gas to make up for the loss of hydrogen fuel and deactivate the hydrogen generator control and the metering valve control 270.

The reverse switch 256 when activated sends a signal 258 to the motor control 216 activating the motor control for reverse motor mode and deactivating the engine control 214. The accelerator 250 controls the motor speed in reverse. After the reverse switch 258 is turned off, the vehicle returns to automatic operation or manual operation as the case may be.

The system of FIG. 2A controls hydrogen flow from the hydrogen generator to the engine by controlling the hydrogen production of the hydrogen generator which is controlled by the voltage regulator 280 from mechanical signals 280 or electronic signals 280 from the accelerator 250. The system of FIG. 2A has no metering valve control. When the vehicle is in the engine on mode and the hydrogen generator is in the on mode, the voltage regulator 280 is operational and controlled by the accelerator 250 as described above. When the hydrogen generator controller and the hydrogen generator are in the off mode, the voltage regulator 280 is off or non-operational. In all other aspects, the operation of the system of FIG. 2A is identical to the operation of the system of FIG. 2. In other words, the systems of FIGS. 2 and 2A operate in the same manner with the exception that the system of FIG. 2 controls the hydrogen flow into the engine through a metering valve control and the system of FIG. 2A controls hydrogen flow into the engine by regulating hydrogen production from the hydrogen generator via voltage regulator 280.

For the vehicles 10B and 10A illustrated in FIGS. 4 and 4A, there is no motor generator and thus no need to switch the operating mode of the motor to and from motor mode and generator mode during operation of the vehicle in the automatic mode, reverse mode or manual mode since the motor 54 has no generating mode and generating capacity. The alternator or the generator 92 will automatically produce current to charge the battery 24 when the engine operation is initiated as described for vehicles 10B and 10C (FIGS. 4 and 4A).

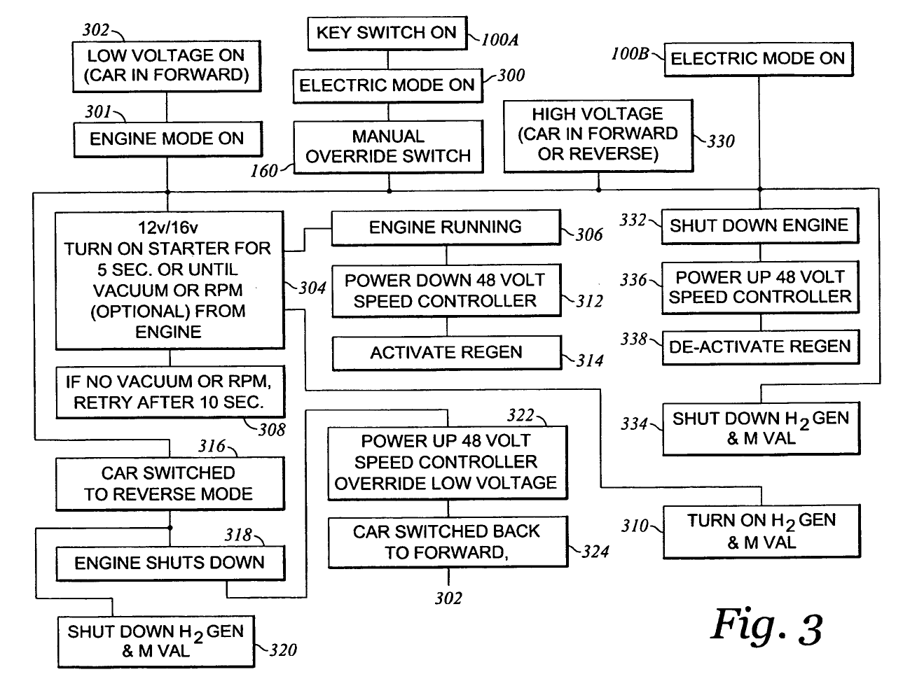

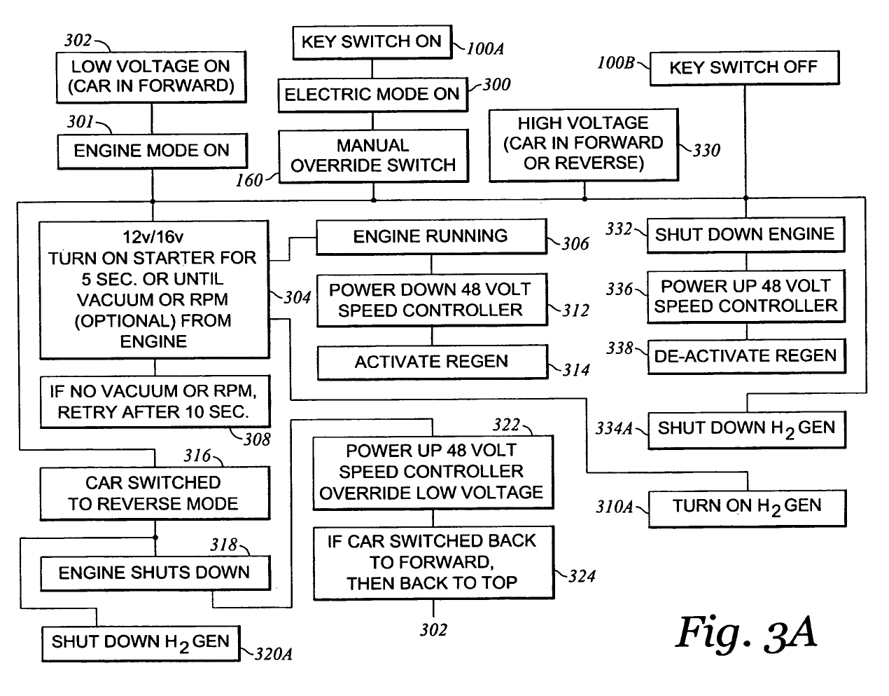

Referring to FIG. 3, a hybrid vehicle flow chart is illustrated which shows that when the on/off switch 100A (key switch) is turned on, it initiates the default electric [motor] mode 300 where operation of the vehicle is carried out with an electric motor or motor generator in the motor mode. The default mode can be interrupted by the manual override switch 160 as described above. The system automatically monitors the voltage of the battery. If the battery voltage is low 302, the system automatically turns on the starter 304 for 5 seconds, or until it monitors an engine vacuum or an rpm threshold for the engine which indicates that the engine has started up and is running 306. The hydrogen generator (H₂ Gen) and the meter valve (M Val) are also turned on 310. The time the starter is on can be between 1 and 10 seconds. If no vacuum is detected or the predetermined rpm's are not reached, the system automatically will retry to start the engine after 10 seconds, or some other time between 1 and 30 seconds 308. If the engine is running, the system powers down the 48 volts speed controller 312 and activates the regen or charger mode 314 of the motor generator. For the vehicles 10B and 10C of FIGS. 4 and 4A, the engine automatically powers the generator or alternator 92 as the case may be. A voltage regulator prevents overcharging of the battery system. If during the low battery charge mode when the engine is on, i.e. operating and the operator wishes to reverse the vehicle, the operator activates a reverse switch and the system switches the vehicle to the reverse mode 316. The reverse mode involves engine shut down 318, shut down of the hydrogen generator and metering valve 320, and powering up the 48 volts speed controller 322 which overrides the low voltage status of the battery to permit reversing of the vehicle with the motor generator in the motor mode or the motor as described above in a reverse direction. If or when the car is switched back to a forward motion, in other words if the reverse switch is turned off, then operation of the vehicle is returned 324 to the automatic low battery charge mode described above.

If the battery has a high voltage or a voltage above the threshold voltage 330, the engine will not be started up when the key switch is turned on, or if the engine is running, it will be shut down 332. Likewise, the hydrogen generator and metering valve will not be turned on, and if on, they will be turned off 334. The system will power up the 48 volts speed controller 336 and deactivate the regen or charger mode 338 by switching the motor generator from the generating mode to the motor mode to operate the vehicle with the motor generator in the motor mode.

When the key switch is turned off 100B, the electric mode is turned off, the engine is shut down 332, the hydrogen generator is shut down 334, and the metering valve is closed 334.

As described above, the manual override can reverse the above automatic operation by switching from electric motor mode 300 to engine mode 301 or vice versa as described herein.

The manual override switch 160 takes the vehicle out of the automatic mode and (1) starts up the engine 304, activates the hydrogen generator and metering valve 310 and takes the operation out of the electric mode 300, or (2) shuts down the engine 318, shuts down the hydrogen generator and metering valve 320 and switches to the electric mode 300.

Referring to FIG. 3A, a hybrid vehicle flow chart very similar FIG. 3 is illustrated. Common elements and steps of FIG. 3A are already described with respect to FIG. 3 above, and will not be redescribed. In the flow chart of FIG. 3, the system no longer employs a metering valve. In the system of FIG. 3A, the throttle controls the hydrogen production of the hydrogen generator by voltage control as described above with respect to vehicle 10A of FIG. 1A and vehicle 10C of FIG. 4A. Thus, when the hydrogen generator is turned on, such as when the engine is started 304, the hydrogen generator is also turned on 310A. When the car is switched to the reverse mode, the engine is shut down 318 and the hydrogen generator is shut down 320A. Similarly, when the key switch or starter switch is turned off 10B, the hydrogen generator is shut down 334A.

1. A hybrid golf car type vehicle comprising an engine with on and off modes, the engine off mode being the default mode; a reversible motor operable in a forward or reverse direction, the motor in the forward direction being the default mode; a drive shaft connected to the motor, the motor driving the drive shaft in a forward or reverse direction; a differential connected and driven by the drive shaft; two independent power axles connected to and driven by the differential; a directional drive train connecting the engine to the drive shaft, the engine driving the drive train and the drive shaft in the forward direction when the engine is turned on and the motor is turned off, and the motor driving the drive shaft in the forward or reverse direction when the motor is turned on and the engine is turned off; a battery to power the motor; and an alternator connected to and driven by the drive shaft when the engine drive the drive shaft, the alternator charging the battery.

2. The hybrid golf car type vehicle according to claim 1 including a controller monitoring the voltage of the battery and adapted to start the engine and turn off the motor if turned on when the battery charge drops below a predetermined voltage, and to turn off the engine if operating and turn on the motor when the battery charge is at least 48 volts.

3. The hybrid golf car type vehicle according to claim 1 including a reversing switch adapted when activated to stop the engine if operating and turn on the motor in the reverse direction or if the motor is turned on switching the motor to the reverse direction.

4. The hybrid golf car type vehicle according to claim 2 including an on/off switch adapted when turned on to turn on the motor in a forward direction when the battery charge at least equals the predetermined voltage, or to start the engine when the battery charge is less than the predetermined voltage, and when the on/off switch is turned off to turn off the motor and the engine.

5. The hybrid golf car type vehicle according to claim 1 including a manual override switch which can be turned on to a first on mode which turns off the engine if operating and turns on the motor in the forward direction regardless of the battery charge.

6. The hybrid golf car type vehicle according to claim 5 wherein the manual override switch can be turned on to a second on mode which turns off the motor if operating and turns on the engine regardless of the battery charge.

7. The hybrid golf car type vehicle according to claim 1 including an accelerator adapted to control the power of the motor generator when the motor is turned on and to control the power of the engine when the engine is turned on.

8. The hybrid golf car type vehicle according to claim 3 including a controller having a microprocessor, the controller monitoring the battery charge and the on/off status of the engine, the controller controlling operation of the engine and motor, the reverse switch connected to the controller and the controller carrying out the reverse operation.

9. The hybrid golf car type vehicle according to claim 2 wherein the on/off switch is directly connected to the controller and the on/off switch when turn on sends a signal to the controller which carries out the automatic operation of the vehicle

10. The hybrid golf car type vehicle according to claim 2 including a reverse switch, the reverse switch connected directly to the controller and the controller carrying out the reverse operation.

11. The hybrid golf car type vehicle according to claim 2 including a manual override switch having a first on mode, the manual override switch connected directly to the controller and the controller carrying out the operation of the first on mode which turns off the engine if operating and turns on the motor in the first direction regardless of the battery charge.

12. The hybrid golf car type vehicle according to claim 8 including an accelerator to control the power of the motor and engine, the accelerator connected to the controller and the controller carrying out control of the power of the motor when the motor is turned on and controlling the power of the engine when the engine is turned on.

13. The hybrid golf car type vehicle according to claim 2 including a starter motor to start the engine, the starter motor connected to the controller and the controller activating the starter motor, for a predetermined time, to start up the engine when operation of the vehicle requires the engine to be turned on.

14. The hybrid golf car type vehicle according to claim 13 wherein the controller monitors the on/off status of the engine and activates the starter motor periodically until the engine starts.

15. A hybrid golf car type vehicle comprising an engine with on and off modes, the engine off mode being the default mode; a motor generator having a reversible direction motor mode and a generating mode, the motor mode in the forward direction being the default mode; a drive shaft connected to the motor generator, the motor generator adapted to drive the drive shaft in a forward or reverse direction when the motor generator is in the motor mode; a differential connected and driven by the drive shaft; two independent power axles connected to and driven by the differential; a directional drive train connecting the engine to the drive shaft, the engine when turned on driving the drive train and the drive shaft in the forward direction and driving the motor generator in the generator mode, and the motor generator driving the drive shaft in the forward or reverse direction when the motor generator is in the motor mode and is turned on; and a battery to power the motor generator in the motor mode, the motor generator charging the battery when the motor generator is in the generator mode, and the engine is turned on.

16. The hybrid golf car type vehicle according to claim 15 including a controller monitoring the charge of the battery and on/off status of the engine, the controller adapted to starting the engine and switching the motor generator to the generator mode when the battery drops below a predetermined voltage, and turning off the engine if operating and switching the motor generator to the motor mode in a forward direction when the battery exceeds a second predetermined voltage.

17. The hybrid golf car type vehicle according to claim 16 including a reversing switch which when activated turns off the engine if the engine is turned on and switches the motor generator to the motor mode in a reverse direction, or switches the motor generator in the motor mode from a forward direction to a reverse direction if the motor generator is already turned on.

18. The hybrid golf car type vehicle according to claim 16 including an on/off switch connected to the controller and the controller when the switch is turned on switching the motor generator into the motor mode in a forward direction when the battery charge at lease equals a predetermined voltage, or starting the engine and switching the motor generator to the generating mode when the battery charge is less than the predetermined voltage, and turning off the motor generator and the engine when the on/off switch is turned off.

19. The hybrid golf car type vehicle according to claim 16 including a manual override switch which can be activated to a first on mode or a second on mode, the manual override switch connected to the controller and the controller when the manual override switch is switched to a first on mode turning off the engine if operating and switching the motor generator from generator mode to a motor mode in the forward direction regardless of the battery charge, and the controller when the manual override switch is switched to the second on mode switching the motor generator from the motor mode to the generator mode and starting the engine regardless of the battery charge.

20. The hybrid golf car type vehicle according to claim 16 including an accelerator adapted to control the power of the motor generator when the motor generator is in the motor mode and to control the power of the engine when the engine is turned on, the accelerator connected to the controller which controls the power of the motor generator in the motor mode and the engine when turned on.
